(19) United States
(12) Patent Application Publication
(10) Pub. No.: US 2014/0032693 A1
(43) Pub. Date: Jan. 30, 2014

(54) Priority Alert System

(71) Applicant: Richard A. Mavrogeanes, Wallingford, CT (US)

(72) Inventor: Richard A. Mavrogeanes, Wallingford, CT (US)

(21) Appl. No.: 13/627,448

(22) Filed: Sep. 26, 2012

Related U.S. Application Data
(60) Provisional application No. 61/677,238, filed on Jul. 30, 2012.

(51) Int. Cl. H04L 29/08

(52) U.S. Cl. CPC H04L 67/10
USPC 709/207

(57) ABSTRACT

A method for transmitting a priority alert to a client computer provides for the streaming of a video alert message, displaying text of a video alert message or displaying a website identifier of a video alert message to pre-selected display zones. The client computer automatically polls a remote server. The alerts are automatically transmitted without requiring input at the client computer.

### CROSS-REFERENCE TO RELATED APPLICATION

This application claims the priority of U.S. Provisional Patent Application No. 61/677,238 filed on Jul. 30, 2012, the disclosure of which is incorporated by reference in its entirety.

### BACKGROUND

This disclosure relates generally to methods for providing priority alerts to computer systems. More particularly, the present disclosure relates to the automatic transmittal of priority alerts which are communicated in different modes.

### SUMMARY

Briefly stated, a method to transmit a priority alert from a server hosting a priority alert file to a client computer controlling a screen comprises periodically polling the hosting server. The transmission method comprises retrieving the priority alert file from the hosting server if an alert is identified and reading the contents of the priority alert file. If the priority alert file contains a video, the alert message is video streamed on the screen. If the priority alert file contains text, the text of the alert message is displayed on the screen. If the priority alert file contains a web page identifier, the web page is identified on the screen. The transmission is automatically accomplished without user input at the client computer.

The priority alert file is preferably encrypted and the transmission method further comprises decrypting the priority alert file. The type of video is determined. The specified color for the text is also determined. In some embodiments, the method generates a “no cancel” command, and the priority alert message is prevented from cancellation in the event of a “no cancel” command. Zones are selected for displaying the priority alert message for client computer systems which control more than one screen.

A duration time is incorporated into the priority alert file and the transmission method further comprises terminating priority alert video, text or website identification upon expiration of the time duration. In some embodiments, a screen-type parameter is provided, and the video or text is displayed in accordance with the screen-type parameter. The display of a priority alert message may be automatically terminated.

In one embodiment, a method to transmit a priority alert to a client computer controlling at least one display zone from a server hosting a priority alert file comprises loading a computer interface program on a client computer. The client interface program is employed to periodically poll the hosting server. The priority alert file is retrieved from the hosting server if an alert is identified. The contents of the priority alert file are read. The priority alert file is used to identify at least one zone for displaying a priority alert. If the priority alert file contains a video, the alert is video streamed at each selected zone. If the priority alert file contains text, the text is displayed at each selected zone. If the priority alert file contains a web page identifier, the web page is displayed at each selected zone. The transmission for display at the selected display zones is automatically accomplished without user input at the client computer.

In another embodiment, a method to transmit a priority alert to a client computer controlling a display screen from a server hosting a priority alert file comprises loading an interface program on the client computer. The hosting server is periodically polled. If an alert is identified, the priority alert file is accessed from the hosting server. The contents of the priority alert file are read. If the priority alert file contains a video, the alert message is video streamed on the screen. If the priority alert file contains text, the alert message is displayed on the screen. The transmission and various forms of display are automatically accomplished without user input at the client computer.

For some applications, the client computer further controls a plurality of screens, each defining a display zone, and the transmission method further comprises selecting zones from the priority alert file for displaying the priority alert.

### BRIEF DESCRIPTION OF THE DRAWINGS

FIG. 1 is a schematic annotated view illustrating principal hardware components employed in a priority alert system;

FIG. 2 is a representative screen print for a user interface for the priority alert system; and

FIGS. 3A and 3B together constitute a flow chart illustrating an embodiment of a priority alert system.

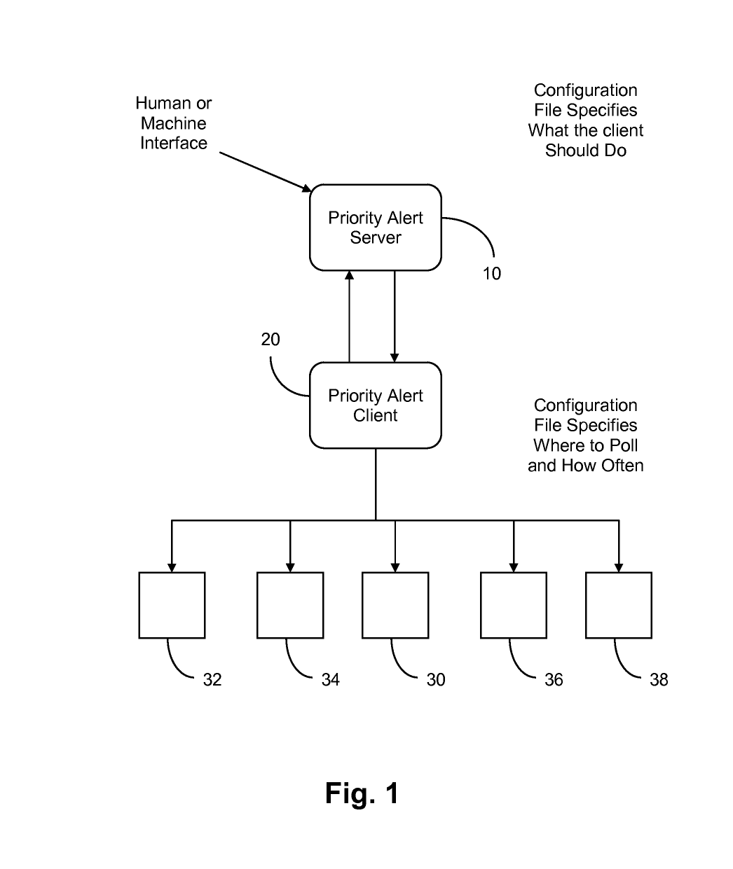

### DETAILED DESCRIPTION

With reference to the drawings, a method of providing a video alert, in various modes to any number of computer desktops and/or screens, does not require any action to be taken on behalf of the computer desktop operator. The priority alert (PA) is typically employed for emergency notifications and, when warranted, is automatically transmitted to the computers and screens of the priority alert client.

The priority alert system is best described in terms of a remote priority alert server 10 and a computer 20 of a priority alert client. The client computer 20 may connect or network with any number of computers, computer desktops and/or screens for displaying a priority alert. Representative display screens are designated by the numerals 30, 32, 34, 36 and 38 in the drawings.

The priority alert system allows any number of computer desktops or screens to receive and display a live video alert, typically for emergency notifications, without the computer desktop operator taking any action whatsoever to trigger the alert. The priority alert system continuously operates to display a series of priority alerts PA₁, PA₂, PA₃ . . . PAₙ of various forms. For a given PAₙ, the PAₙ may be displayed on all screens 30, 32, 34, 36 and 38 or any subset of the screens depending on a defined display zone Z₁, Z₂, Z₃ . . . Zₙ . . .

A PA interface program is installed on the client computer 20 and upon startup, the interface program reads a configuration file in the following form:

```
<discovervideo>
        <inputurl>http://[server]/priorityalert</inputurl>
        <checkminutes>0.3</checkminutes>
        <visible>true</visible>
        <usercontrol>true</usercontrol>
        <zone>public</zone>
</discovervideo>
```

Where:
Inputurl—identifies the server 10 that the program will poll;
Checkminutes—sets how often the server 10 will be polled;
Visible—sets whether the PA interface file will be visible on the computer 20;
Usercontrol—sets whether the user is allowed to modify the settings; and
Zone—sets or defines the zone Zₙ to which the PAₙ will be displayed.

The computer 20 via the interface program reads the Inputurl to retrieve an encrypted XML file. The PA interface file application decrypts the PAₙ file and reads its contents. The contents specify the display of the priority alert PAₙ according the following parameters:
If the alert is for video, the video type, which may be H264, MPEG2, MPEG1, or Windows Media is determined. The video is displayed either in normal or full screen for a specified duration.
If the alert is for text, the text using the specified color is displayed, for the specified duration.
If the alert is for a web page, the web page is displayed for the specified duration.
If the alert specifies “nocancel”, then the user is prevented from closing the alert.

The PA hosting server 10 delivers an encrypted file to the client computer 20 containing the following:

```
?xml version=“1.0”?>
<alert>
  <zone>[zone]</zone>
          <action>cancel</action>
          <videourl>[videosource]|10|[type]|</videourl>
          <weburl>[weburl]</weburl>
          <alerttext>[text]</alerttext>
          <textcolor>[hex color code]</textcolor>
          <time>[current date/time]</time>
          <expire>[current date/time plus duration]</expire>
          <allowcancel>[true/false]</allowcancel>
          <title>[title text]</title>
</alert>
```

Where:
Zone—is text designating one or more zones Zₙ, or the keyword “ALLZONES”;
Action—is “video” to alert with video, “text” to alert with text, “web” to alert with web page, or “cancel” to end the alert;
Alerttext—is the text to display during a text alert;
Textcolor—is the color of the text to display during a text alert;
Time—is the time the PAₙ was created;
Expire—is the time the PAₙ was created plus the time duration of the PAₙ;
Allowcancel—true or false defines whether the operator can cancel an alert; and
Title—is the title of the PAₙ.

The values contained in the above PA file are typically automated from a system database, where a user interface enters or modifies database values and a software handler reads the database, forms the above PA syntax, and encrypts the file on the server 10 so that it can be read by client computer 20.

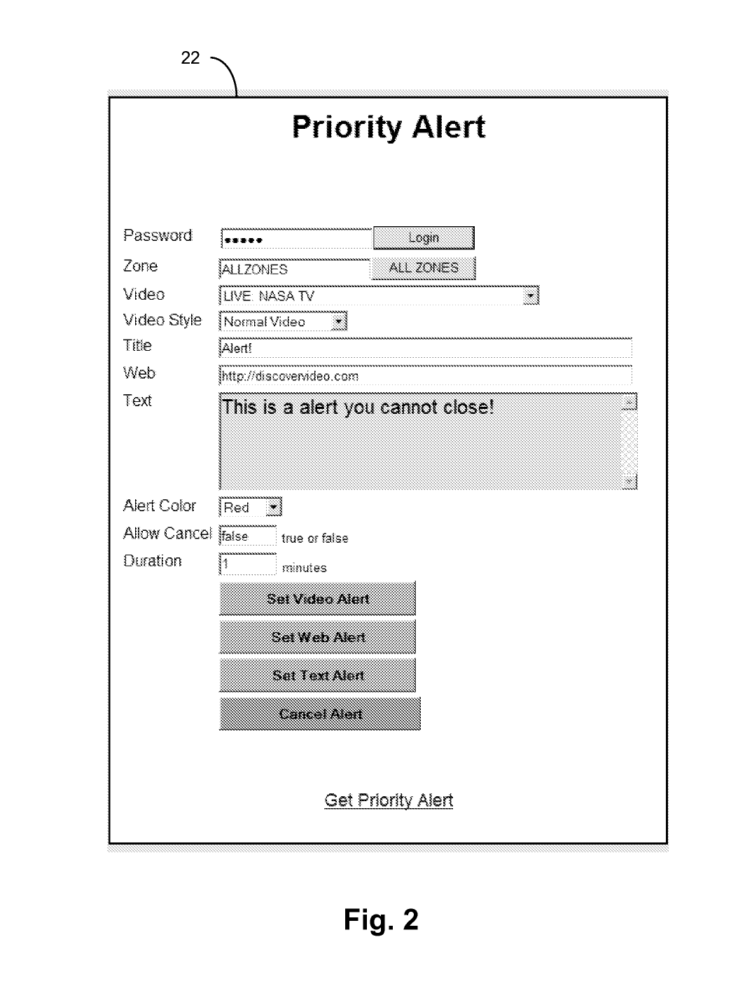

A representative user interface screen print 22 is illustrated in FIG. 2. Various operational parameters, which in some instances are selected by the client, are identified.

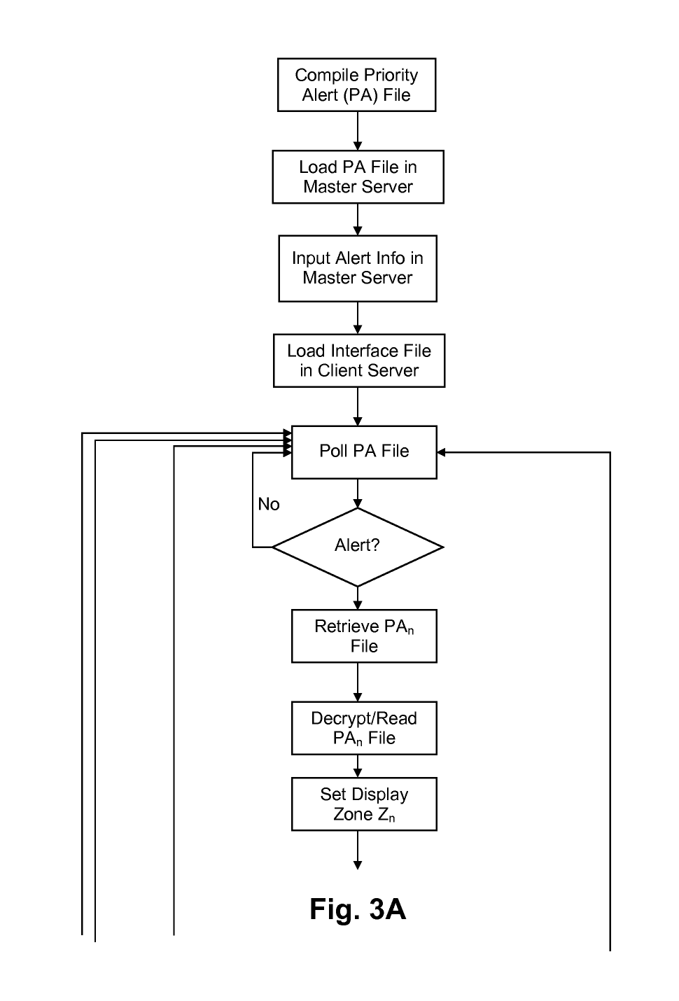

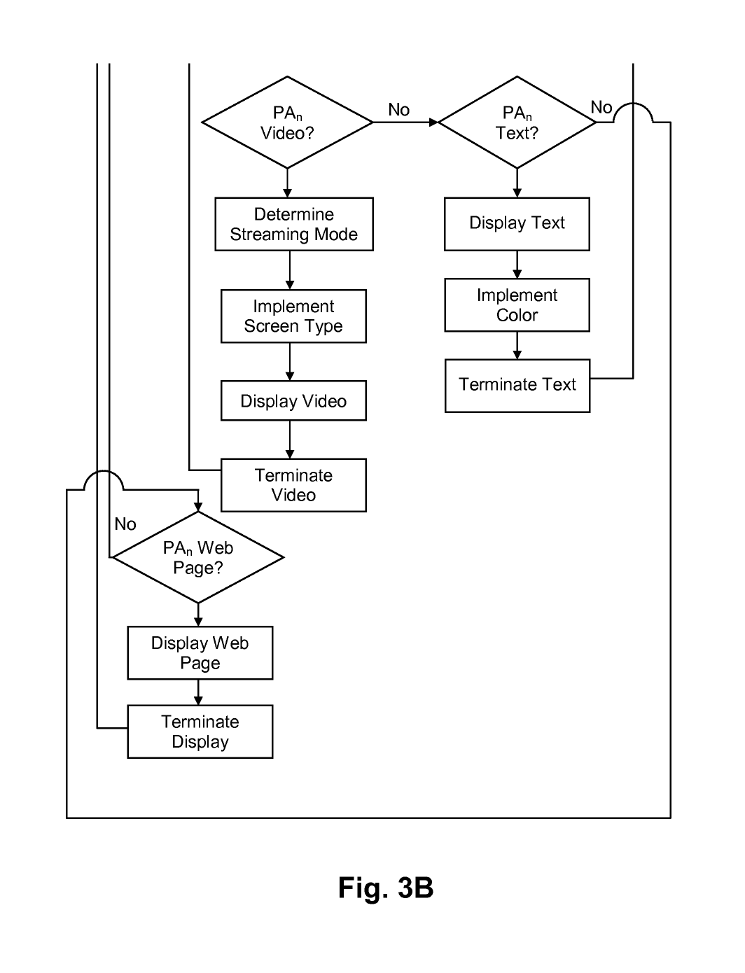

Representative steps of one embodiment of transmitting a priority alert is illustrated in FIGS. 3A and 3B. A priority alert file is compiled and loaded into the master server 10. Alert information is input into the master server 10 either via a human or a machine interface. An interface file is loaded into a client computer 20. In accordance with the interface file, the client computer 20 continuously polls the master server PA file at a pre-established interval or frequency. If a priority alert PAₙ is identified, the priority alert file is retrieved, decrypted and read by the client computer 20.

If the priority alert PAₙ is in the form of a video, the streaming mode is determined. The screen type, such as full, half or other screen configuration, is implemented. The streaming video is displayed until termination of the video which is set by a pre-established time span or time duration. The system returns to the polling mode.

If the priority alert PAₙ is not a video, but a text priority alert, the text is displayed. The pre-selected color for the text is implemented. Upon expiration of the duration time span, the text is terminated, and the system is returned to the polling mode.

If the priority alert PAₙ is in the form of a web page, the web page is displayed. Upon termination of the duration time span, the system is again returned to the polling mode which continuously operates at a given polling frequency.

It will thus be appreciated that a priority alert, which may take the form of either streaming video, text or a web page, is continuously displayed where applicable without requiring any action or computer input by the client.

What is claimed:

1. A method to transmit a priority alert message to a client computer controlling a screen from a server hosting a priority alert file comprising:
(a) periodically polling said hosting server;
(b) retrieving said priority alert file from said hosting server if an alert is identified;
(c) reading the contents of said priority alert file;
(d) if said priority alert file contains video, video streaming said alert message on said screen;
(e) if said priority alert file contains text, displaying text of said alert message on said screen;
(f) if said priority alert file contains a web page identifier, displaying said web page identifier on said screen; and
(g) where steps (a)-(f) are automatically accomplished without user input at said client computer.

2. The method of claim 1 wherein said priority alert file is encrypted and further comprising decrypting said priority alert file.

3. The method of claim 1 wherein step (d) further comprises determining the video type of the video.

4. The method of claim 1 wherein step (e) further comprises specifying a color for the text.

5. The method of claim 1 further comprising generating a “no cancel” command and preventing cancellation of the priority alert message in the event of the “no cancel” command.

6. The method of claim 1 further comprising selecting zones for displaying the priority alert message.

7. The method of claim 1 further comprising incorporating a duration time into said priority alert file and further comprising terminating priority alert video, text or website identification upon expiration of the time duration.

8. The method of claim 1 further comprising providing a screen-type parameter and displaying said video or text in accordance with the screen-type parameter.

9. The method of claim 1 further comprising automatically terminating the display of a priority alert message.

10. A method to transmit a priority alert to a client computer controlling at least one display zone from a server hosting a priority alert file comprising:
(a) loading a client interface program on a client computer;
(b) employing said client interface program to periodically poll said hosting server;
(c) retrieving said priority alert file from said hosting server if an alert is identified;
(d) reading the contents of said priority alert file;
(e) using the priority alert file to identify at least one selected zone for displaying a priority alert;
(f) if said priority alert file contains video, video streaming said alert at each said selected zone;
(g) if said priority alert file contains text, displaying text of said alert at each said selected zone;
(h) if said zone priority alert file contains a web page identifier, displaying said web page identifier at each said selected zone; and
(i) where steps (b)-(h) are automatically accomplished without user input at said client computer.

11. The method of claim 10 wherein said priority alert file is encrypted and further comprising decrypting said priority alert file.

12. The method of claim 10 wherein step (f) further comprises determining the video type of the video.

13. The method of claim 10 wherein step (g) further comprises specifying a color for the text.

14. The method of claim 10 further comprising generating a “no cancel” command and preventing cancellation of the priority alert in the event of the “no cancel” command.

15. The method of claim 10 further comprising incorporating a duration time into said priority alert file and further comprising terminating priority alert video, text or website identification upon expiration of the time duration.

16. The method of claim 10 further comprising providing a screen-type parameter and displaying said video or text in accordance with the screen-type parameter.

17. The method of claim 10 further comprising automatically terminating the display of a priority alert.

18. A method to transmit a priority alert message to a client computer controlling a display screen from a server hosting a priority alert file comprising:
(a) loading an interface program on said client computer;
(b) periodically polling said hosting server;
(c) accessing said priority alert file from said hosting server if an alert is identified;
(d) reading the contents of said priority alert file;
(e) if said priority alert file contains video, video streaming said alert message on said screen;
(f) if said priority alert file contains text, displaying text of said alert message on said screen; and
(g) where steps (b)-(f) are automatically accomplished without user input at said client computer.

19. The method of claim 18 wherein said priority alert file is encrypted and further comprising decrypting said priority alert file.

20. The method of claim 18 wherein said client computer further controls a plurality of screens each defining a display zone and further comprising selecting zones from said priority alert file for displaying the priority alert.
